(19) United States
(12) Patent Application Publication
(10) Pub. No.: US 2011/0151203 A1
(43) Pub. Date: Jun. 23, 2011

(54) DESSERT DECORATION SYSTEM AND METHOD

(76) Inventor: Sharon D. Nalley, Bainbridge Island, WA (US)

(21) Appl. No.: 12/950,506

(22) Filed: Nov. 19, 2010

Related U.S. Application Data
(63) Continuation of application No. 12/062,793, filed on Apr. 4, 2008, now abandoned.
(60) Provisional application No. 60/910,163, filed on Apr. 4, 2007.

(51) Int. Cl. B32B 3/10

(52) U.S. Cl. 428/195.1

(57) ABSTRACT

A food decoration is provided that includes an image imprinted on a substrate, a support member for supporting the substrate on the food, and an attachment that affixes the substrate to the support. A system is also provided that includes an electronic apparatus adapted to store, and in some cases manipulate, images and to transfer the images to a substrate, such as via a printer, for attachment to the support member.

### BACKGROUND OF THE INVENTION

1. Field of the Invention

The present disclosure pertains to the creation and implementation of fanciful ornamentations on food and, more particularly, to the design, fabrication, and application of decorations to food, such as desserts.

2. Description of the Related Art

The presentation of food generally refers to the visual arrangement and composition of the food on a serving medium, usually ready to be eaten. Stylish chefs resort to artistic creativity in developing their signature presentations.

All forms of display are employed that appeal to all senses, not just sight, and appearing not just at meals but on other occasions, such as the use of pastries and desserts at birthday and anniversary celebrations.

A well-known example of decorations for foods is in the presentation of birthday cakes. In addition to the usual artistic flair in the use of colored frosting to portray landscapes, athletic events, and to deliver written messages, numerous objects have been used to decorate the exterior of a cake. These include enhancements that are placed directly in the frosting without penetrating into the cake itself, as well as candles and candleholders that are placed into the cake or pastry.

The following patents disclose various suggestions for adorning birthday cakes.

Mauro, U.S. Pat. No. 2,285,599, describes a decoration that includes pictoral representations of plant life. These representations are present on a sheet of paper that is placed directly on the frosting.

Koretzky, U.S. Pat. No. 2,406,777, describes a birthday cake holder in which a stem is pushed into a cake in a vertical orientation. A saucer-like portion is formed to have the appearance of a flower on which the candle is placed.

Steinhils, U.S. Pat. No. 2,499,079, describes a cake holder device for cakes that includes an element inserted into a cake in a horizontal orientation. A three-dimensional decoration resembling a horse is located at one end of the device. These decorations are not suitable for use on the top of a dessert or food item, and they are used with a candle, which could be hazardous to a paper item.

Scherer, U.S. Pat. No. 2,786,345, illustrates a candleholder for birthday cakes that includes a leg, which is penetrated into a cake in a vertical orientation. Because this device uses a candle, it would be unsuitable for use with flammable decorations.

Shinnick, U.S. Pat. No. 3,308,705, describes a cake decorator that includes a spike penetrated into a cake and a music box having candleholders radiating outward therefrom supported by the spike. A three-dimensional decorative structure having the appearance of a shoe sits on top of the music box. This is a complex and cumbersome decoration that is used with candles, which are incompatible with paper or flammable decorations.

Greenblatt, U.S. Pat. No. 4,801,478, depicts a musical ornament that includes an elongated tapered shank penetrated into a cake in a vertical orientation, and the music box has the appearance of a three-dimensional heart. An ornament in the form of a bride and groom with a stickpin can be inserted into the cake in a vertical orientation. This approach requires mechanical or electro-mechanical or electronic devices to play music and is used with a candle, which again is unsuitable for use with flammable decorations.

Spurgeon et al., U.S. Patent Publication No. 2002/0008751 describes a decorating system for edible items in which a scanner provides digital images or a library of digital images to be used with a controller and a printer to print out selected images. The printed edible media can be applied to a cake directly onto the cake itself without being supported above the cake.

Stewart, U.S. Patent Publication No. 2003/0161913, pertains to a decorating system for foodstuffs, such as a cake, in which edible films can be preprinted using a printer with edible inks. These films are then applied directly to the frosting or the food item without being supported on or above the food item by a mounting post or stem.

Huang, U.S. Design Pat. No. 349,261, pertains to a cake decoration that includes a three-dimensional element resembling a mouse that is used with a candle, and hence is not suitable for use with flammable material.

The basic principles of food presentation are built around safety, sanitation, and creativity. The utilization of candles in conjunction with flammable materials is unsafe as well as unsanitary.

### BRIEF SUMMARY OF THE INVENTION

A system and method of decorating food is provided in the present disclosure. Although the representative embodiments of the disclosure are described in more detail hereinbelow in conjunction with desserts, such as cakes, pies, and the like, it is to be understood that the present disclosure pertains to all food items in addition to birthday cakes and the like.

In one embodiment, the decorations include a stick portion, such as a tube, straw, toothpick, skewer, popsicle stick, plain stick, and the like, having an adornment portion attached to the top thereof. An adhesive can be used to attach the adornment portion to the stick portion. A free end of the stick portion is pushed into the dessert, preferably in a vertical orientation, although other orientations can be used, and the dessert becomes adorned with the adornment portion above the dessert. The decorations can be provided in sets that include a plurality of decorations.

In one class of embodiments, the adornment portion can be a photographic image, or the adornment portion can include two photographic images placed back to back. More specifically, two photographic images can be placed on a die-cut piece of paper with a crease or score between the two photographic images, and when the paper is folded along the crease or score it can be attached to the top of the stick portion so that the photographic images appear back to back in mirror-like fashion.

In another class of embodiments, the adornment portions can be small, three-dimensional figures, such as animal figures. The stick portions can vary in length and color, depending on a selected decorative motif. In addition, the stick portion can have one or more extensions for supporting a plurality of adornment portions. In another embodiment, the stick portion forms a part of the displayed image.

The adornment portions can vary in subject matter, such as flower, butterflies, tractors, puppies, kittens, princesses, ballet dancers, airplanes, planets, dinosaurs, birds, and reptiles, among others.

In accordance with one embodiment of the invention, a food decoration is provided that includes a substrate having an image imprinted thereon, means for supporting the substrate on the food, and means for adhering the substrate to the supporting means.

In accordance with another aspect of the present embodiment, the substrate can be formed of flammable paper or nonflammable materials. The adhering can take place via glue, adhesive, or releasable adhesive. The support means can be one from among a post, a straw, a stick, a tube, a toothpick, a skewer, and a popsicle stick, of the same or varying lengths and including one or more extensions thereon to separately support individual substrates. The image can include indicia, text, symbols, photographs, and other visual representations.

In accordance with another embodiment of the present disclosure, a system for food decoration is provided. The system includes an electronic apparatus adapted to store in an electronic format images and to transfer the images from the electronic format to a substrate, a support member adapted to support the substrate on the food, and an attachment that affixes the substrate to the support.

In accordance with yet another embodiment, a kit is provided, the kit including a plurality of substrates, each having at least two areas on which identical mirror images can be applied thereon; a plurality of reusable support posts that are each adapted to support at least one substrate on the food; and an adhesive for adhering the substrate to the support post.

In accordance with another aspect of the foregoing embodiment, the kit includes a plurality of images to be applied to the substrates. In one form the images are stored on an electronic storage medium, such as a memory or CD.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an illustration of the unassembled components of a food decoration formed in accordance with one embodiment of the present disclosure;

FIG. 2 is an illustration of a step in a method of constructing a food decoration using the components of FIG. 1 in accordance with the present disclosure;

FIG. 3 is an illustration of the assembled food decoration in accordance with a method of the present disclosure;

FIG. 4 is an illustration of another embodiment of the present disclosure;

FIG. 5 is an illustration of yet a further embodiment of the present disclosure;

FIG. 6 is an illustration of still yet another embodiment of the present disclosure;

FIG. 7 is a further illustration of another embodiment of the present disclosure; and

FIG. 8 is a diagram of a system formed in accordance with the present disclosure.

### DETAILED DESCRIPTION OF THE INVENTION

The present disclosure is directed to adornments for food, such as desserts, that utilize an innovative method for designing, constructing, and using the same. While the present disclosure is described in the context of desserts, it is to be understood that the system and method of the present disclosure can be used with all types of food items that can receive a support stick or stem. Safety, sanitation, as well as creativity are important considerations in the utilization of the present system and method. Notably absent from the following description is the use of candles in conjunction with the adornments due to the risk of fire, prohibitions of flammable materials in certain buildings and outdoor environments, and overall safety for those using the adornments.

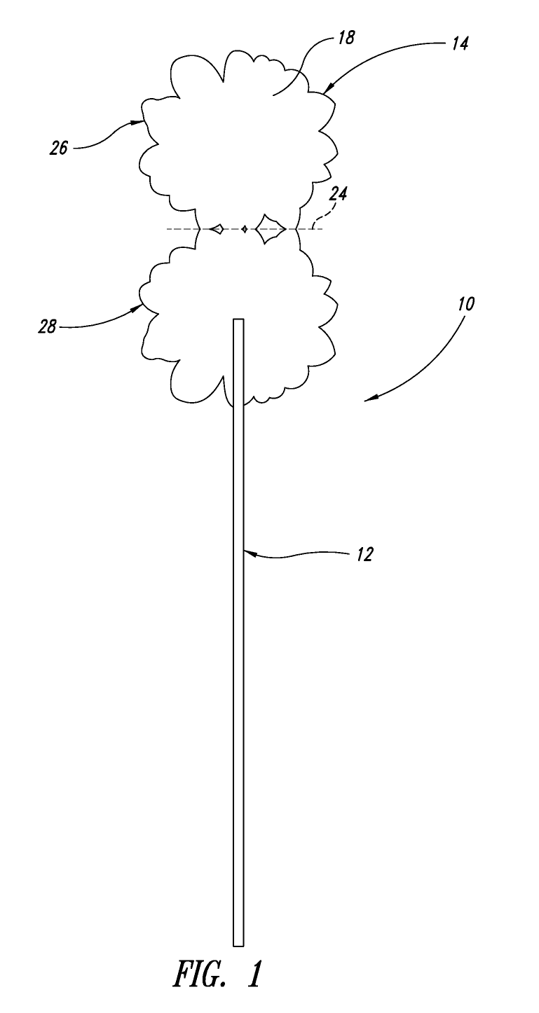

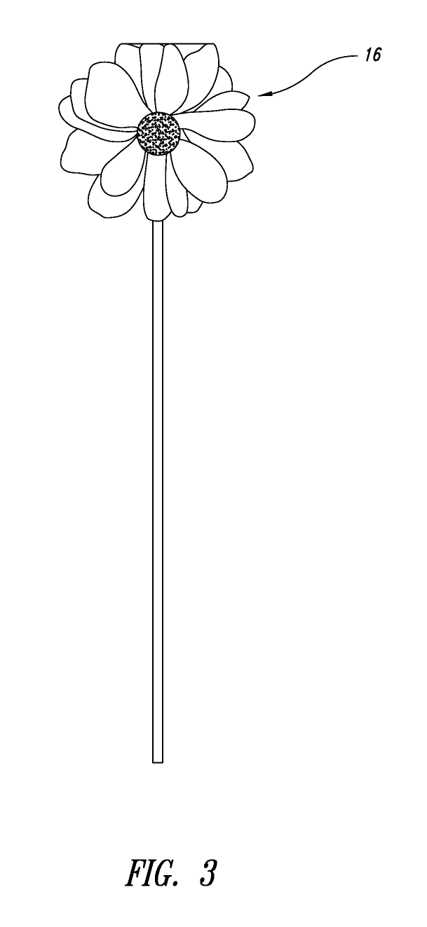

FIG. 1 illustrates one form of the present disclosure in which an adornment 10 is shown having a support member 12 in the form of an elongate rigid stick member combined with a substrate 14 to form a representation of a stemmed flower 16, as shown in FIG. 3.

The sticks 12 are preferably made of plastic, such as polypropylene having a rectangular, round, or circular cross-sectional configuration with an approximate width of 3 mm. Length and color can vary depending upon the imagery to be attached to the stick 12. In other words, the stick 12 is intended in this embodiment to form a portion of the represented item, in this case the stem of a flower. For items that are to be shown in flight or otherwise suspended above the dessert, a clear stick can be used. It is to be understood that the stick can take various forms, such as a popsicle stick, a skewer, a toothpick, and have different cross-sectional configurations, such as circular, square, rectangle, triangle, and other known geometric shapes. The stick can also be hollow, such as a straw, or tubular or cylindrical, or it can be solid. It can be formed from a variety of materials including wood, plastic, metal, glass, and the like. In one embodiment, the stick 12 can be reused after proper cleaning, and hence is formed of material that, in one embodiment, is safe for cleaning with hot, soapy water, such as in a dishwasher.

Although the stick 12 shown in FIG. 1 is a single stem, it is to be understood that the stick can have a plurality of projections extending therefrom on which can be supported a plurality of substrates. The projections can be of different lengths and extending in different directions and can be curved as well as straight, as can be the stick 12 itself. Thus, various shapes and configurations thereof are possible, limited only by the imagination of the designer. Moreover, the support for the adornment portion can be the handle of a fork or knife placed in the cake.

While the stick is shown in FIG. 1 to have a blunt end on each terminal portion, it is to be understood that the stick can be pointed or tapered to facilitate easy insertion into materials that are harder than cake, such as frozen ice cream. Preferably the sticks are rigid to hold the adornment away from the decorative frosting on the cake. However, the sticks can be bendable or resilient so that they either retain their bent shape or slowly or quickly return to their original state.

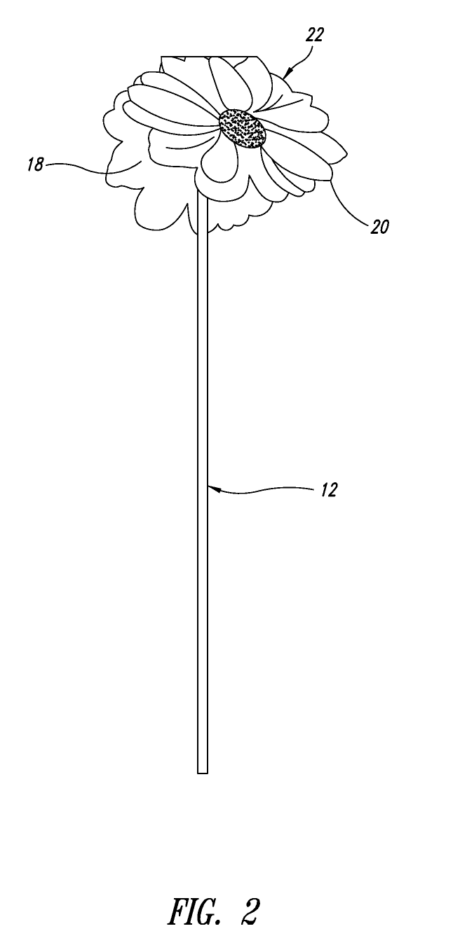

As shown in FIGS. 1-3, the substrate 14 has two sides, an adhesive side 18 and an image side 20. The substrate 14 can be of a simple geometric shape or cut into the shape of the item that it portrays. In the example shown in FIGS. 1-3, the substrate 14 is cut into the shape of a flower and the image 22 of the flower is imprinted on the image side 20 of the substrate 14. In this embodiment, the substrate 14 has a hinge line 24 about which the substrate is bent. The image line 24 forms the line of symmetry about which the substrate 14 is shaped so that the top half 26 is a mirror image of the bottom half 28 and will match up when the substrate 14 is bent about the hinge line 24, as shown in FIGS. 2 and 3.

The hinge line 24 can be vertical or horizontal, as desired or as necessary to accommodate designs in which the one side, such as the top, provides too small of an area for a hinge line. Thus, the hinge line 24 must be adapted to the particular image formed on the substrate 14 to provide the requisite symmetry and present a pleasing appearance when the adornment 10 is viewed from different angles or perspectives. Multiple hinge lines that are coincidental may be used as the shape of the image may require.

In another embodiment, multiple substrates can be concatenated or attached together to create a composite image, such as adding a tail to an animal image or a sleigh behind reindeer. This can be accomplished in one form by having part of a second substrate overlap on a first substrate so that the adhesive on the second substrate adheres to the outside of first substrate. Alternatively, multiple posts 12 may be required to support a single composite image or the post may need multiple branches to support multiple substrates connected together.

Ideally the substrate 14 is formed from heavy coated paper stock, such as 80#, although it can be other material, such as nonflammable material or plastic that is readily bendable and can be affixed to the stick 12. The substrate 14 can be preformed with adhesive on it or the adhesive can be applied to the adhesive side 18 at the time of construction of the adornment 10.

The images can include photographs, paintings, text, symbols, and other indicia or visual imagery, such as without limitation flowers, butterflies, tractors, puppies, kittens, princesses, ballet dancers, airplanes, plants, dinosaurs, birds, and reptiles, to name a few. Ideally, these images are photographic, with exceptions made only when photographs are not possible, such as with dinosaurs. Even in those cases, the execution will still ideally be photo realistic. The preferred photographic quality and how it transforms the surface of the desert into a particular place and environment is what gives the adornments their maximum impact.

The length of the stick 12 can vary depending on the image being displayed. For example, butterfly images can be attached to clear plastic sticks approximately 12 inches in height so the butterflies appear to fly over the dessert.

This configuration can also be used for airplanes, birds, planets, and the like. Other images, such as puppies, dancers, and safari animals will have shorter sticks (approximately 4 inches) that are intended to be completely inserted into the desert so the imagery appears to be standing directly on it. In some instances, the sticks will be colored to accentuate and blend in with the image. For example, sunflowers would be attached to 12 inch green sticks to mimic the look of flower stems.

In another embodiment, the adornments can include sticks longer than is needed, and the user can trim the sticks to the desired length. Hence, the sticks are constructed of material that can be easily shortened, such as with kitchen scissors or knife. In addition, smaller adornments can be combined with shorter sticks for smaller desserts, such as cupcakes.

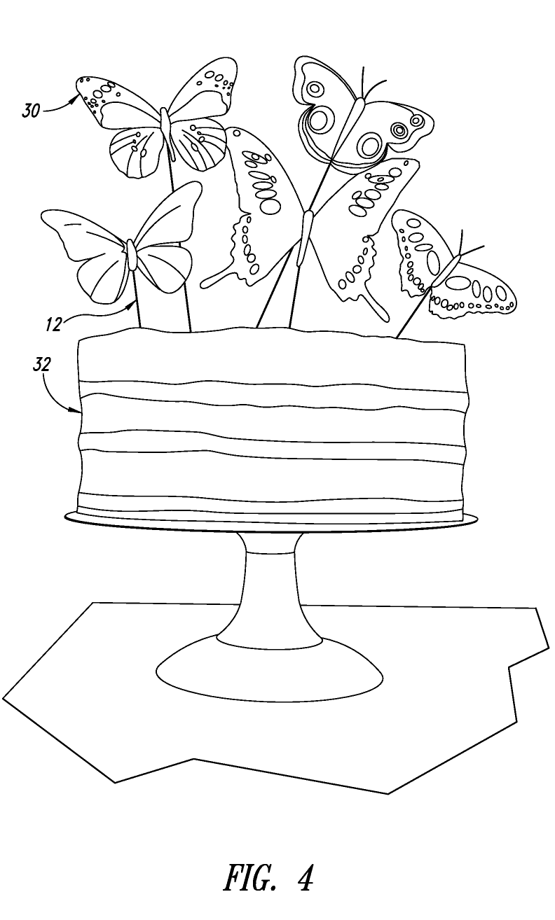

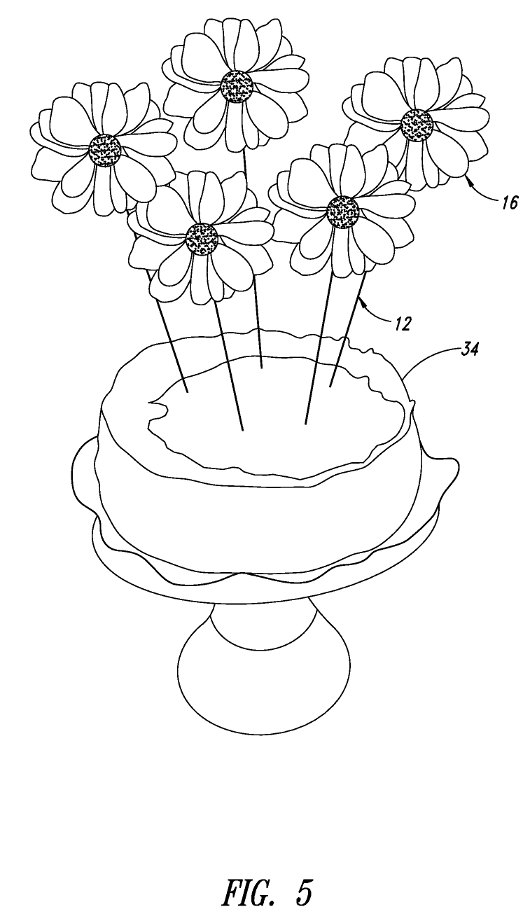

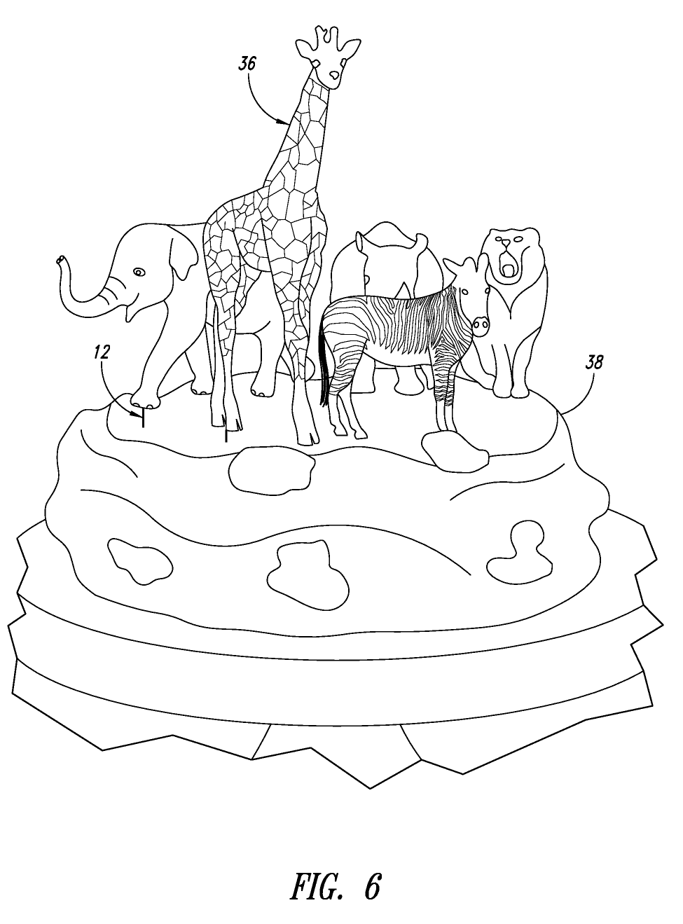

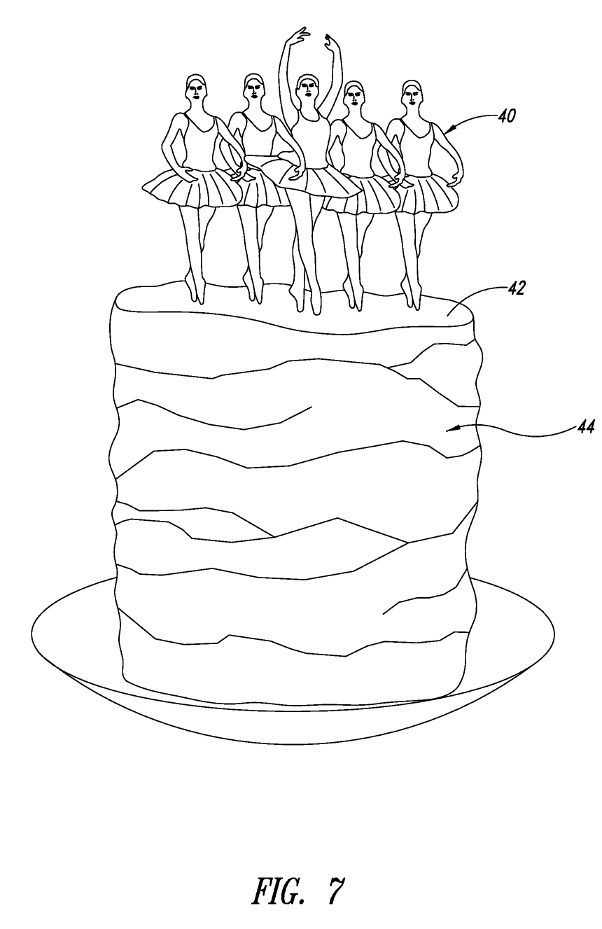

The adornments can be used on almost any desert. For example, FIG. 4 shows a plurality of butterflies 30 suspended above a cake 32 by the stick 12. FIG. 5 illustrates a plurality of the flowers 16 formed in FIGS. 1-2 as an arrangement growing out of a cake 34 with stems 12. In FIG. 6, a plurality of animal shapes 36 in three-dimensional format are supported on a desert 38 via sticks 12 extending from the bottom of the animals' feet. And in FIG. 7, ballerinas 40 are shown dancing on the frosting 42 of a multi-layer desert 44.

As will be readily appreciated, the foregoing embodiments of the present disclosure illustrate a quick and simple way of decorating any food item, from a traditional cake to pie, tiramisu, ice cream, tart, or any other food soft and thick enough to support the sticks. In one embodiment, the adornments 10 can be sold in kit form having a container with the sticks 12 and the substrates 14 unassembled in the container. Alternatively, the adornment 10 can be preassembled and sold in packs of multiple adornments, such as 5 flower images, that are then ready to be used. In yet another kit form, the sticks 12 can be sold with blank substrates and a CD with images and photographs for downloading to a computer, selection by the user, and printing on to the substrate, which can have an adhesive on a back surface protected by a removable liner.

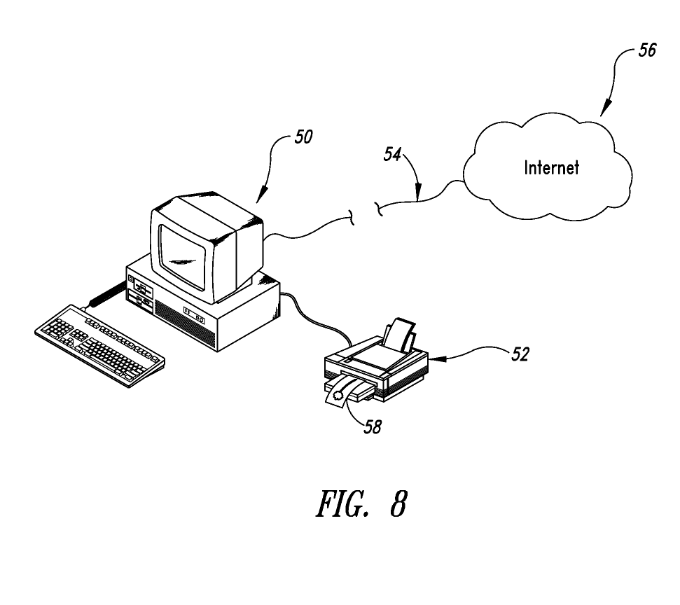

In another embodiment shown in FIG. 8, an electronic apparatus, in this case a computer 50, has a printer 52 attached thereto. The computer 50 has a memory on which can be loaded a plurality of images in electronic format. These images can be obtained from a storage device, such as a floppy disk or CD, or can be obtained via an electronic connection, such as a cable 54 connected to the Internet 56 where images can be downloaded and stored on a memory in the computer 50. Selected images, such as graphic images, photographs, and the like, can then be processed on the computer using available software to allow the user to manipulate the images as desired and output the same onto the substrate 58, such as paper, which can then be applied to the support member or stick. With the use of available software, the images can be manipulated in size, orientation, color, and shape, and they can be combined with other images to achieve the desired effect of the adornment.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A food decoration adapted to be adjusted with scissors, comprising:
a substrate having two mirror images imprinted thereon with a bend line at a top of each image;
a plastic support tube having a rigidity to support the substrate on the food and formed to be trimmable in length with the scissors; and
an adhesive to adhere the substrate to the support so that the substrate is bent along the bend line to adhere the substrate to itself with the bend line formed at a top of each of the two mirror images, which is a top of the food decoration.

2. The decoration of claim 1 wherein the substrate comprises multiple substrates attached together to form a composite image.

3. The decoration of claim 1 wherein the substrate comprises non-flammable material.

4. The decoration of claim 1 wherein the adhesive comprises an adhesive pre-applied to the substrate and protected by a liner.

5. The decoration of claim 4 wherein the adhesive is adapted to releasably attach the substrate to the support.

6. The decoration of claim 1 wherein the support is hollow and has a diameter of 3 mm and a length of at least 12 inches.

7. The decoration of claim 1 wherein the support is adapted to appear as part of the image imprinted on the substrate.

8. The decoration of claim 1 wherein the image comprises one from among indicia, text, symbols, and a photograph.

9. A system to generate adornments that can be adjusted in size with the use of scissors for display on food, the system comprising:
an electronic system adapted to store in an electronic format images and to transfer the images from the electronic format to a substrate on which mirror images are formed about a line of symmetry that is at a top of each image;
a plastic support member adapted to support the substrate on the food and to be trimmed in length with the scissors; and
an attachment that affixes the substrate to the support by attaching the substrate to itself and to the support member through bending the substrate about the line of symmetry.

10. The system of claim 9 wherein the substrate comprises flammable paper.

11. The system of claim 9 wherein the substrate comprises nonflammable material.

12. The system of claim 9 wherein the attachment comprises an adhesive.

13. The system of claim 12 wherein the adhesive is adapted to releasably attach the substrate to the support member.

14. The system of claim 9 wherein the support member comprises a hollow tube having a diameter of 3 mm and a length of at least 12 inches.

15. The system of claim 14 wherein the support member comprises a plurality of extensions, each extension adapted to be attached to a single substrate.

16. The system of claim 15 wherein each extension of the plurality of extensions has a length that is different than a length of the other extensions of the plurality of extensions.

17. The system of claim 9 wherein the images comprise at least one from among indicia, text, symbols, and photographs.

18. The system of claim 17 wherein the substrate is adapted to be configured into a three-dimensional object.

19. The system of claim 9 wherein the electronic apparatus comprises a computer and a printer.

20. The system of claim 19, further comprising means for coupling the computer to a worldwide network of computers to electronically transfer images.

21. The system of claim 9 wherein the electronic apparatus comprises a printer configured to print two images on a single substrate, the substrate sized and shaped to be folded so that the two images appear back to back.

22. The system of claim 21 wherein the attachment comprises an adhesive formed on an opposite side of the substrate than the images to adhere the substrate to itself and to the support member.

23. A food decoration kit adapted for use with scissors, comprising:
a plurality of substrates, each having at least two areas on which identical mirror images can be applied thereon, the mirror images intersecting at a fold line that is at a top of each image;
a plurality of reusable support posts that are each adapted to support at least one substrate on the food and to be trimmed in length with the scissors; and
an adhesive for adhering the substrate to the support post by adhering the substrate to itself and the support post when the substrate is folded onto itself at the fold line.

24. The kit of claim 23, comprising a plurality of images for application to the substrate.

25. The kit of claim 24, wherein the plurality of images are stored on an electronic storage medium for printing onto the plurality of substrates.
